(19) United States
(12) Patent Application Publication
(10) Pub. No.: US 2025/0314790 A1
(43) Pub. Date: Oct. 9, 2025

(54) FULL WAVEFORM INVERSION FOR SUBSURFACE CHARACTERIZATION

(71) Applicant: Saudi Arabian Oil Company, Dhahran (SA)

(72) Inventors: Young Seo Kim, Dhahran (SA); Hong Liang, Katy, TX (US); Hussain J. Salim, Dhahran (SA)

(21) Appl. No.: 18/625,688

(22) Filed: Apr. 3, 2024

(51) Int. Cl. G01V 1/30; G01V 1/28

(52) U.S. Cl. CPC G01V 1/303; G01V 1/282; G01V 2210/614; G01V 2210/6222

(57) ABSTRACT

Example methods and systems for full waveform inversion (FWI) for subsurface characterization are disclosed. One example method includes obtaining multiple field shot gathers of a subsurface reservoir. Each of the multiple field shot gathers is divided into corresponding multiple two-dimensional (2D) patches. An objective function of a FWI process is determined based on the corresponding multiple 2D patches of each of the multiple field shot gathers. A velocity model of the subsurface reservoir is determined based on the objective function of the FWI process. The velocity model is provided to determine one or more well locations within the subsurface reservoir.

### TECHNICAL FIELD

The present disclosure relates to computer-implemented methods and systems for full waveform inversion for subsurface characterization.

### BACKGROUND

Accurate, near-surface information is important in the construction of subsurface geological models and plays a pivotal role in mitigating hydrocarbon drilling hazards. Consequently, the estimation of near surface P-wave velocity information is a primary objective of geophysical data processing. A reliable near surface velocity model can reduce errors in well location determination. Full Waveform Inversion (FWI) is a technique for constructing shallow velocity models.

### SUMMARY

The present disclosure involves methods and systems for full waveform inversion for subsurface characterization. One example method includes obtaining multiple field shot gathers of a subsurface reservoir. Each of the multiple field shot gathers is divided into corresponding multiple two-dimensional (2D) patches. An objective function of a FWI process is determined based on the corresponding multiple 2D patches of each of the multiple field shot gathers. A velocity model of the subsurface reservoir is determined based on the objective function of the FWI process. The velocity model is provided to determine one or more well locations within the subsurface reservoir.

The previously described implementation is implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium. These and other embodiments may each optionally include one or more of the following features.

In some implementations, before dividing each of the multiple field shot gathers into the corresponding multiple 2D patches, the multiple field shot gathers are filtered to generate multiple shape-filtered field shot gathers, where filtering the multiple field shot gathers includes convolving the multiple field shot gathers with a shaping filter, and where dividing each of the multiple field shot gathers into the corresponding multiple 2D patches includes dividing each of the multiple shape-filtered field shot gathers into the corresponding multiple 2D patches.

In some implementations, determining the objective function of the FWI process includes determining, for each of the corresponding multiple 2D patches, a respective soft-dynamic time warping (DTW) objective function in a time direction and a respective soft-DTW objective function in a space direction, and determining, based on the respective soft-DTW objective function in the time direction and the respective soft-DTW objective function in the space direction, the objective function of the FWI process.

In some implementations, determining the respective soft-DTW objective function in the time direction includes determining, based on a weighting function, the respective soft-DTW objective function in the time direction.

In some implementations, determining the objective function of the FWI process includes determining, based on a respective synthetic shot gather within each of the corresponding multiple 2D patches, the objective function of the FWI process.

In some implementations, the respective synthetic shot gather within each of the corresponding multiple 2D patches is generated using a Ricker wavelet.

In some implementations, determining the velocity model of the subsurface reservoir includes determining, based on the objective function of the FWI process and an adjoint source vector of the objective function of the FWI process, the velocity model of the subsurface reservoir.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example process of determining a two-dimensional (2D) objective function using soft-Dynamic Time Warping (DTW), according to some implementations.

FIG. 2A illustrates an example of defining a patch in a field shot gather using window sizes windowₜ and windowₓ in Equation 1, according to some implementations.

FIG. 2B illustrates an example of defining a patch in a synthetic shot gather using window sizes windowₜ and windowₓ in Equation 1, according to some implementations.

FIG. 3 illustrates an example method for determining the soft-DTW objective function and its adjoint source in a time direction, according to some implementations.

FIGS. 4A and 4B illustrate a P-wave velocity model and a P-wave density model respectively used in generation of observed shot gathers for a Full Waveform Inversion (FWI) process, according to some implementations.

FIG. 4C illustrates a strongly smoothed model used as the initial model for the FWI process, according to some implementations.

FIG. 5A illustrates an example of an observed shot gather used as field data, according to some implementations.

FIG. 5B illustrates an example of a synthetic shot gather corresponding to the observed shot gather in FIG. 5A and obtained from the initial model shown in FIG. 4C, according to some implementations.

FIG. 5C illustrates an example of shape-filtered observed shot gather obtained using 106 in FIG. 1, according to some implementations.

FIGS. 6A and 6B illustrate example adjoint sources in the time and space directions respectively, according to some implementations.

FIG. 7A illustrates an example preconditioned gradient model at the first iteration, after the final adjoint source is obtained from 114 of FIG. 1, according to some implementations.

FIG. 7B illustrates an example FWI model after 20 iterations, according to some implementations.

FIG. 8A illustrates an initial model used in an FWI process to develop a final FWI model, according to some implementations.

FIG. 8B illustrates the final FWI model obtained from the FWI process, according to some implementations.

FIG. 9A illustrates an example of observed traces from 500 m to 2200 m offsets, according to some implementations.

FIG. 9B illustrates an example of synthetic traces corresponding to the observed traces in FIG. 9A and obtained from the initial model in FIG. 8A, according to some implementations.

FIG. 9C illustrates an example of synthetic traces corresponding to the observed traces in FIG. 9A and obtained from the final FWI model in FIG. 8B, according to some implementations.

FIG. 10A illustrates an example of observed traces from 2500 m to 3600 m offsets, according to some implementations.

FIG. 10B illustrates an example of synthetic traces corresponding to the observed traces in FIG. 10A and obtained from the initial model in FIG. 8A, according to some implementations.

FIG. 10C illustrates an example of synthetic traces corresponding to the observed traces in FIG. 10A and obtained from the final FWI model in FIG. 8B, according to some implementations.

FIG. 11 illustrates an example process for FWI incorporating the objective function in Equation 1, according to some implementations.

FIG. 12 is a block diagram of an example computer system that can be used to provide computational functionalities associated with described algorithms, methods, functions, processes, flows, and procedures, according to some implementations.

FIG. 13 illustrates hydrocarbon production operations that include both one or more field operations and one or more computational operations, which exchange information and control exploration for the production of hydrocarbons, according to some implementations.

Like reference numbers and designations in the various drawings indicate like elements.

### DETAILED DESCRIPTION

Velocity model building and seismic migration in the depth domain have been widely used in the oil and gas industry. While time processing in seismic migration can yield high-resolution migration images with low computing power requirements, the accuracy of time processing can be compromised due to multiple theoretical assumptions in normal moveout (NMO), stack, and/or field static and residual corrections used to delineate continuous geological layers in the final post-stack migration images. In contrast, depth processing in seismic migration can proceed from true topography without the need for redatuming or field static correction. The output of depth processing, i.e., depth migration, allows interpreters to identify reservoirs without the need for depth-to-time or time-to-depth conversion, playing a crucial role in mitigating drilling hazards.

One depth domain velocity model building technology is Full Waveform Inversion (FWI). Utilizing acoustic or elastic wave equation-based numerical modeling, FWI can provide a representation of the seismic acquisition environment through finite difference or finite element methods. FWI is an iterative process. It starts with an initial velocity model of the subsurface and then continuously updates this model to reduce the difference between the observed and simulated waveforms. An accurate initial velocity model is important in FWI because the FWI misfit function can include many local minima that can cause FWI to converge toward undesired solutions, e.g., if the initial velocity model is far from the true velocity model. Additionally, obtaining a representative estimated source wavelet before implementing FWI is challenging, given the barrier presented by the extraction of direct waves from field shot gathers, especially in land data where direct wave amplitudes are often imperceptible to the human eye. Moreover, FWI can be highly sensitive to background noise, lacking the inherent functionality to distinguish signals from noise. This sensitivity to background noise can lead FWI to misinterpret noise as signal, resulting in inaccurate subsurface material property estimations.

This disclosure describes systems and methods that use an objective function in FWI to reduce the sensitivity of FWI to background noise, as well as a shaping filter to process field shot gathers in order to eliminate the need for pre-FWI source wavelet estimation. The objective function is a two-dimensional (2D)-based soft-dynamic time warping (DTW) objective function calculated within patches, with each patch having a 2D window. The FWI can use the objective function to generate a velocity model of a subsurface structure, for example, a subsurface reservoir. In some cases, the velocity model can be used for long-wavelength static correction in time processing of seismic migration. The velocity model can also be used for deeper model building for depth seismic processing. The depth and/or time migration results obtained from the velocity model can provide geological structure under surface and can be used for finding potential reservoir locations.

The disclosed systems and methods provide many advantages over existing systems. As an example, the disclosed objective function in FWI can reduce the sensitivity of FWI to background noise, therefore enhance the robustness of FWI even in the presence of noisy datasets. As another example, the disclosed processing of field shot gathers using a shaping filter can reduce the dependence of FWI on accurate source wavelet estimation. Consequently, more reliable and more accurate subsurface characterization can be achieved. Furthermore, independent calculations of the disclosed objective function between patches can be performed with GPU implementation using relatively small video random access memory (V-RAM) sizes.

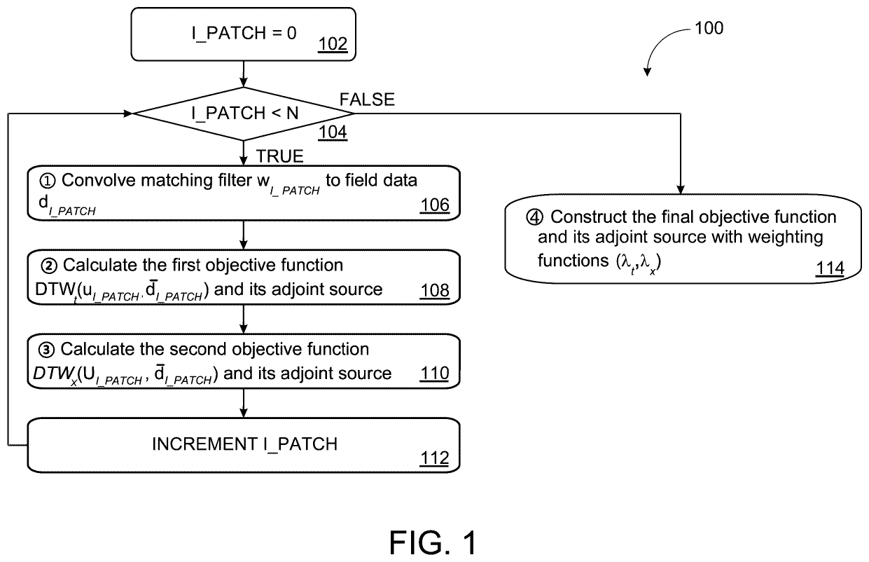

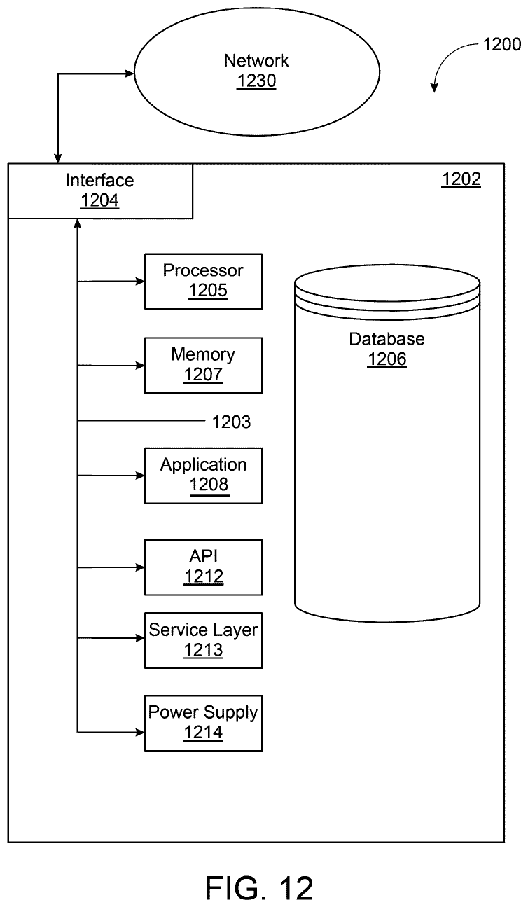

FIG. 1 illustrates an example process 100 of determining a two-dimensional (2D) objective function using soft-DTW. The 2D objective function can then be used in a FWI process to determine a velocity model of a subsurface structure, for example, a subsurface reservoir. For convenience, process 100 will be described as being performed by a system of one or more computers, located in one or more locations, and programmed appropriately in accordance with this specification (e.g., the computer system 1200 of FIG. 12).

In some implementations, the 2D objective function determined by process 100 can be expressed in Equation 1 below.

$$E = {\sum }_{ishot = 1}^{{N}_{s}} {\sum }_{{i}_{patch} = 1}^{N \_ PATCH} [ {λ}_{t} \cdot {DTW}_{t} ( {u}_{{i}_{patch}} , {\tilde{d}}_{{i}_{patch}} ) + {λ}_{x} \cdot {DTW}_{x} ( {u}_{{i}_{patch}} , {\tilde{d}}_{{i}_{patch}} ) ] , \qquad ( 1 )$$

where E represents the 2D objective function. ishot represents a field shot gather. i_{patch} represents a patch, i.e., a small 2D window, in the input dataset of a FWI process. The patch is defined by windowₜ and windowₓ. uᵢ_{_{patch}} represents synthetic data, for example, synthetic shot gathers of a subsurface reservoir, included in i_{patch}. In some cases, the synthetic data can be generated using the second-order in time and eight-order in space finite difference method acoustic wave modeling in every iteration. λₜ and λₓ are weighting functions in time and space directions, respectively. In some cases, λₜ and λₓ can be determined based on empirical tests. In some cases, λₜ is higher than λₓ, e.g., λₜ=0.8 and λₓ=0.2. However, when the input dataset is very noisy, the weighting on λₓ can be increased, for example, λₜ=0.5 and λₓ=0.5. DTWₜ and DTWₓ are soft-dynamic time warping objective functions in time and space directions, respectively, and \tilde{d}ᵢ_{_{patch}} represents shape-filtered field data, and can be obtained using Equation 2 below.

$${\tilde{d}}_{{i}_{patch}} = d ( {x}_{{i}_{patch}} , {t}_{{i}_{patch}} ) * w ( t ) \approx u ( {x}_{{i}_{patch}} , {t}_{{i}_{patch}} ) , \qquad ( 2 )$$

where d(xᵢ_{_{patch}}, tᵢ_{_{patch}}) represents the original field data, for example, observed field shot gathers, within the patch i_{patch}, and w denotes a shaping filter. The shaping filter w(t) can be determined through a deconvolution process after Fourier transform, yielding a complex number in the frequency domain. In some cases, w(t) represents Wiener filter coefficients. In some cases, the deconvolution process can be implemented in two ways using least-squares methods. One least-squares method can be performed in the frequency domain, and the other least-squares method can be performed in the time domain. The time domain implementation can be performed using Levinson recursion. In some cases, the frequency-domain based deconvolution process ban be based on Full Newton Method. Consequently, d(xᵢ_{_{patch}}, tᵢ_{_{patch}})*w(t) may not match the synthetic data u(xᵢ_{_{patch}}, tᵢ_{_{patch}}) within the same patch. In some cases, \tilde{d}ᵢ_{_{patch}}, is closer to the synthetic data than the original field data, obviating the need for source estimation. The use of shape-filtered field data can enable the stable application of dynamic time warping while minimizing cycle skipping issues.

In some implementations, the computer system can perform 106 to 110 in FIG. 1 independently within each patch, without intervention between patches. Given the relatively small domain size of each patch, process 100 can be implemented on a Graphics Processing Unit (GPU) using GPU programming platforms such as NVIDIA® Compute Unified Device Architecture® (CUDA®) or AMD® Radeon Open Compute Ecosystem® (ROCm®).

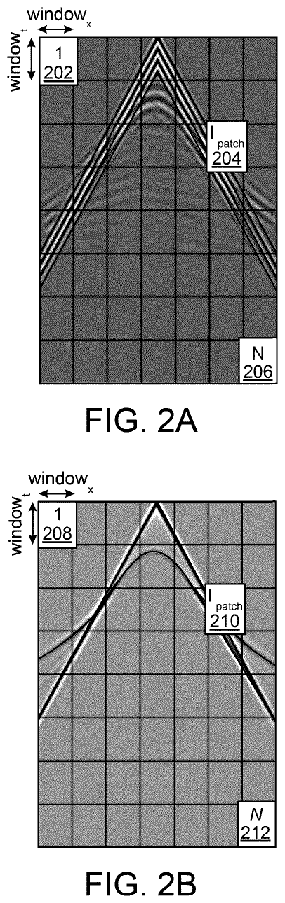

FIG. 2A illustrates an example of defining a patch in a field shot gather using window sizes windowₓ and windowₓ in Equation 1, according to some implementations. For example, patch 202 (i.e., patch #1) in FIG. 2A has a 2D window with sizes windowₜ and windowₓ. Each of the other patches in FIG. 2A, for example, patch 204 (i.e., patch #i_{patch}) or patch 206 (i.e., patch #N), also has a 2D window with sizes windowₜ and windowₓ. The field shot gather represents an observed shot gather.

FIG. 2B illustrates an example of defining a patch in a synthetic shot gather using window sizes window, and window, in Equation 1, according to some implementations. For example, patch 208 (i.e., patch #1) in FIG. 2B has a 2D window with sizes windowₜ and windowₓ. Each of the other patches in FIG. 2B, for example, patch 210 (i.e., patch #i_{patch}) or patch 212 (i.e., patch #N), also has a 2D window with sizes window, and window. The synthetic shot gather in FIG. 2B represents a simulated shot gather generated based on a velocity model and corresponding to the field shot gather in FIG. 2A.

In some implementations, the calculations for a shaping filter used to derive the shape-filtered observed shot gathers, as well as for the objective function E in Equation 1 and its adjoint

$$\frac{\partial E}{\partial u} ,$$

can be conducted independently within each patch in FIGS. 2A and 2B, with no source intervention or overlap between patches.

Returning to FIG. 1, at 102, the computer system selects, from an observed shot gather, a patch with a particular index, e.g., i_{patch}=0, for processing according to Equation 1.

At 104, the computer system determines if all patches in the observed shot gather have been processed according to Equation 1. If not, the computer system performs 106. Otherwise the computer system performs 114.

At 106, the computer system performs, based on Equation 2, a filtering operation on the patch by convolving a shaping filter (i.e., a matching filter) to the observed shot gather within the patch to generate a shape-filtered field data within the patch.

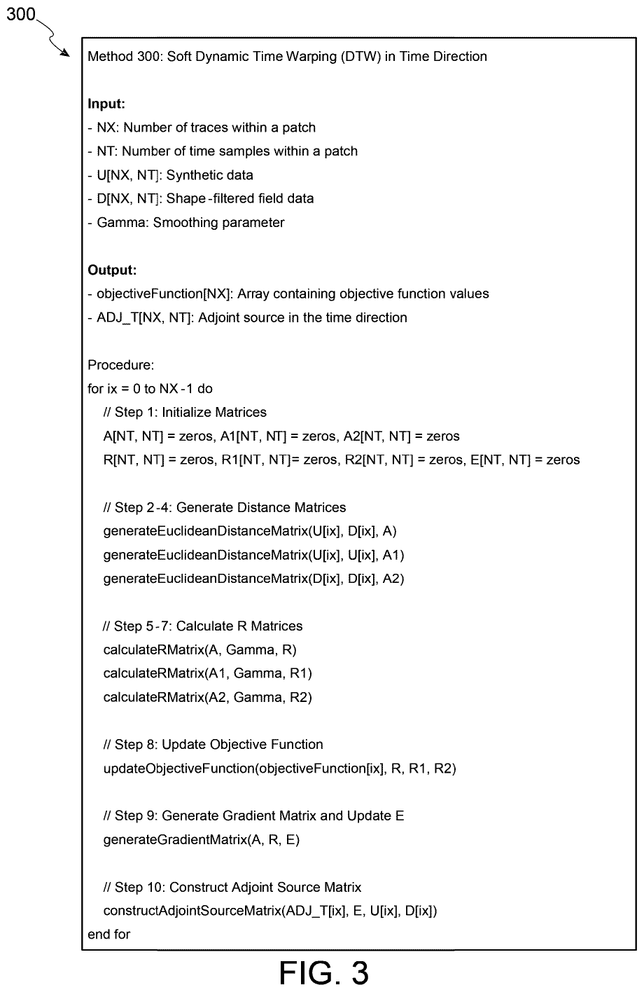

At 108, the computer system determines the soft-DTW objective function and its adjoint source in the time direction. FIG. 3 illustrates an example method 300 for determining the soft-DTW objective function and its adjoint source in the time direction. The soft-DTW objective function, represented by matrix E in FIG. 3, is calculated within a patch, for example, within each patch indexed by ix in FIG. 3, because the shape-filtered field data within the patch, for example, distance matrix D[ix] (e.g., d(xᵢ_{_{patch}}, tᵢ_{_{patch}}) in Equation 1) for the patch indexed by ix, shares the same frequency spectrum range as the synthetic data inside the patch, for example, distance matrix U[ix] (e.g., uᵢ_{_{patch}} in Equation 1) for the patch indexed by ix, allowing for the effective application of the dynamic time warping method. In some implementations, the min operator employed in the original DTW method is globally nondifferentiable, indicating a lack of continuity. Method 300 can address the lack of continuity issue by replacing the min operator in the original DTW method with a soft-minimum operator, making the soft-minimum operator differentiable. Consequently, the adjoint source of the soft-DTW objective function for backpropagation, for example, adjoint source matrix ADJ_T [ix] for the patch indexed by ix, can be derived mathematically. In some cases, incorporating soft-DTW as the objective function in FWI involves 7 matrices, each with dimensions NT*NT (the number of time samples) and NX*NX (the number of traces) in the time and space directions, respectively. Because the calculation of the soft-DTW objective function is confined to a patch, the soft-DTW objective function can be efficiently computed on GPUs with video random access memory (V-RAM) having sizes considerably smaller than the sizes of dynamic random access memory (D-RAM).

At 110, the computer system determines the soft-DTW objective function and its adjoint source in the space direction, using the same methodology as in 108, with the additional step of transposing the synthetic and shape-filtered field data from [NX, NT] to [NT, NX]. In some cases, 110 can be skipped if the field data is minimally affected by background noises. In some implementations, the computer system performs 110 when processing land dataset having short offset data. Traces in short offsets can exhibit a relatively higher degree of contamination compared to traces in far offsets.

At 112, after obtaining the values of objective functions and their corresponding adjoint source vectors for the current patch, the computer system proceeds to the next patch in order to perform 106, 108, and 110 to obtain the values of objective functions and their corresponding adjoint source vectors for the next patch.

At 114, after obtaining the values of objective functions and their corresponding adjoint source vectors across all patches, the computer system determines the final objective function E in Equation 1, along with its final adjoint source vector, by multiplying the adjoint source vectors in the time and space directions with respective weighting factors λₜ and λₓ. The final objective function E and the corresponding adjoint source vector can then be used in the FWI process to determine a velocity model of the subsurface reservoir.

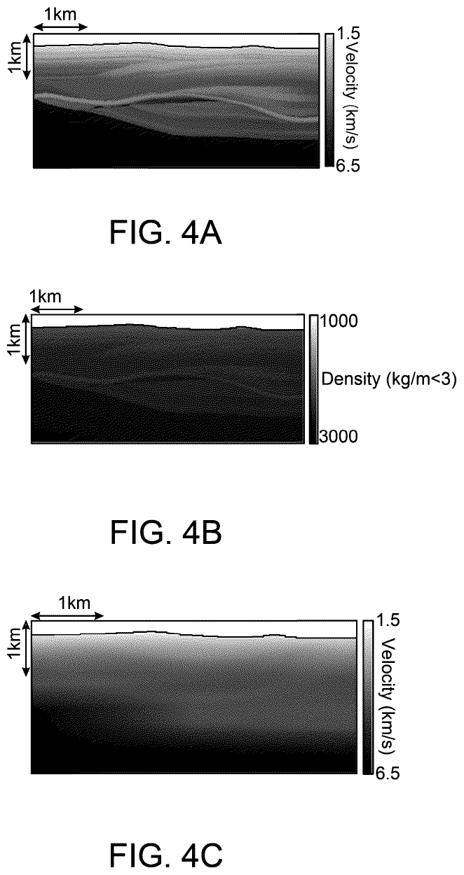

FIGS. 4A and 4B illustrate a P-wave velocity model and a P-wave density model respectively used in generation of observed shot gathers for a FWI process. The observed shot gathers are generated using a first-order acoustic wave equation, incorporating the P-wave velocity model and the P-wave density model shown in FIGS. 4A and 4B respectively. A maximum frequency of 40 Hz and a 20 ms delay time are used to generate the observed shot gathers. The observed shot gathers are filtered using a band-pass filter with frequencies of 3, 4, 16, and 20 Hz. A second-order wave equation, for example, in the form of

$$\frac{{\partial }^{2} u}{\partial {t}^{2}} = {c}^{2} \frac{{\partial }^{2} u}{\partial {x}^{2}} ,$$

is used for forward and backward modeling. A constant density model of 1000 kg/m³ is used, and the P-wave velocity model is updated during the FWI process. The synthetic shot gathers are generated using a Ricker wavelet with a peak frequency of 7 Hz and no delay time as the source wavelet.

FIG. 4C illustrates a strongly smoothed model used as the initial model for the FWI process. For the objective function parameters in Equation 1, the window lengths in the time and space directions, i.e., windowₜ and window, in Equation 1, are set to 100 ms and 400 m, respectively, and weighting factors λₜ and λₓ in Equation 1 are set to 0.5 and 0.5 respectively.

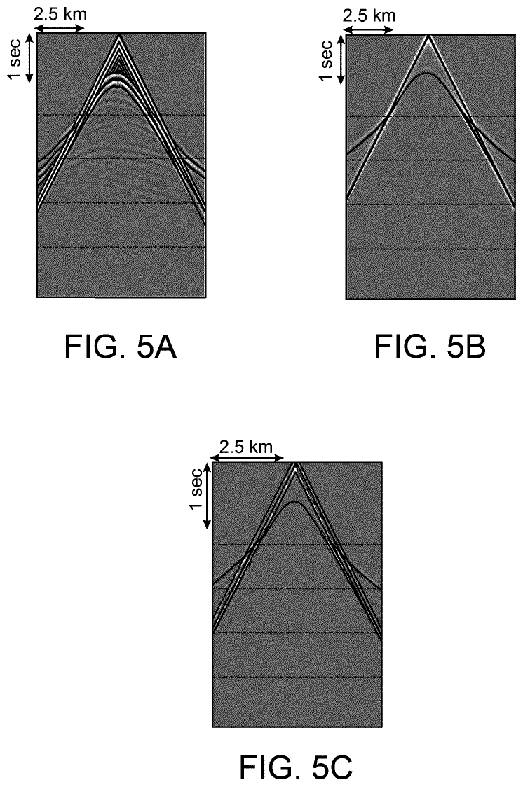

FIG. 5A illustrates an example of an observed shot gather used as field data. FIG. 5B illustrates an example of a synthetic shot gather corresponding to the observed shot gather in FIG. 5A and obtained from the initial model shown in FIG. 4C. The waveforms of the synthetic traces in the synthetic shot gather in FIG. 5B diverge significantly from those of the observed traces in the observed shot gather in FIG. 5A, and the initial events of the observed traces come later than those of the synthetic traces. In some cases, this discrepancy between the synthetic traces and the observed traces is due to variations in the time shift of source wavelets and the order of wave equations used in the generation of the observed shot gather in FIG. 5A and the synthetic shot gather in FIG. 5B. In some cases, the first arrival times in FIG. 5A and FIG. 5B are different because the synthetic traces in FIG. 5B are obtained from the initial model in FIG. 4C different from the true model used to generate the observed shot gather in FIG. 5A, and from source wavelet different than the source wavelet used to generate the observed shot gather in FIG. 5A (because the true source wavelet is unknown).

FIG. 5C illustrates an example of shape-filtered observed shot gather obtained using 106 in FIG. 1. The waveform and arrival times of the initial events in the observed traces in the shape-filtered observed shot gather in FIG. 5C closely resemble those of the synthetic traces in the synthetic gather in FIG. 5B. When compared to the waveform of the synthetic shot gather in FIG. 5B, the waveform of the shape-filtered observed shot gather in FIG. 5C is closer to the waveform of the observed shot gather in FIG. 5A. Therefore, running the FWI process using the shape-filtered observed shot gather in FIG. 5C instead of the synthetic shot gather in FIG. 5B can help avoid convergence of the FWI process to local minima.

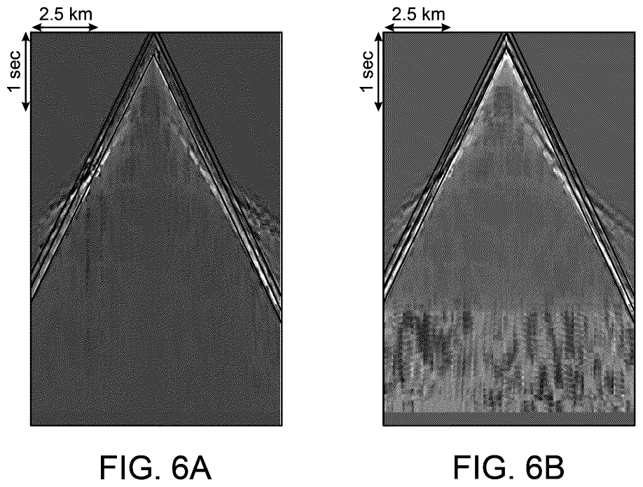

FIGS. 6A and 6B illustrate example adjoint sources in the time and space directions respectively. The adjoint sources allow the derivation of a gradient vector for the velocity update. The adjoint sources are obtained after the calculation of the corresponding objective functions and correspond to taking partial derivatives of the corresponding objective functions with respect to the corresponding synthetic shot gather. The adjoint sources can be backpropagated with modeling operator and then used for the velocity update.

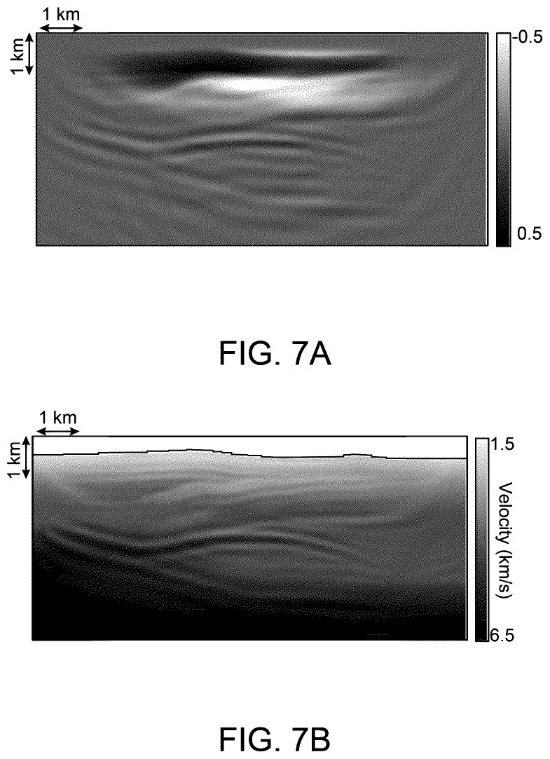

FIG. 7A illustrates an example preconditioned gradient model at the first iteration, after the final adjoint source is obtained from 114 of FIG. 1. FIG. 7B illustrates an example FWI model after 20 iterations. FIG. 7B shows that process 100 is effective in developing the FWI model, even when a source wavelet quite distinct from the true source wavelet with different time shifts is used in developing the FWI model. For example, FIG. 7A shows an example preconditioned conjugate gradient vector that can be used for the velocity update. The preconditioned conjugate gradient vector shows different signs of velocity update in the shallow area (which correspond to the right directions for the velocity update in the shallow area), as well as correct velocity update direction in the salt area (e.g., the area in the middle of FIG. 7A). FIG. 7B shows the final velocity model after the FWI process. The inverted model in FIG. 7B is very similar to the true P-wave velocity model in FIG. 4A from the shallow area to the salt area. Additionally, process 100 is robust in developing the FWI model despite the absence of low-frequency components below 3 Hz in the shot gather data.

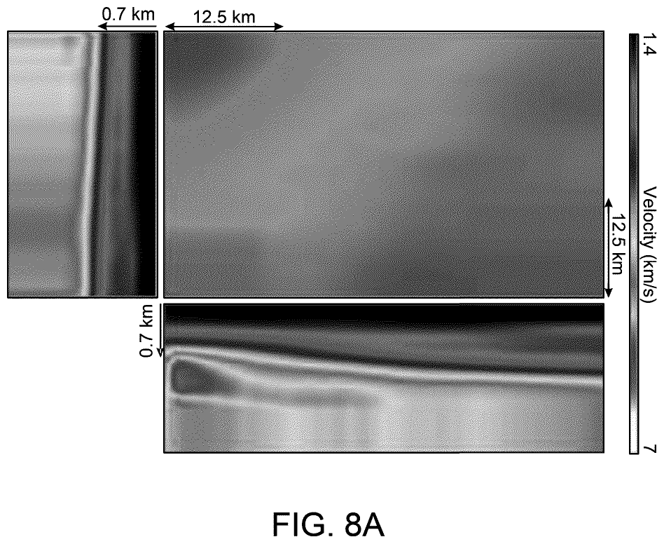

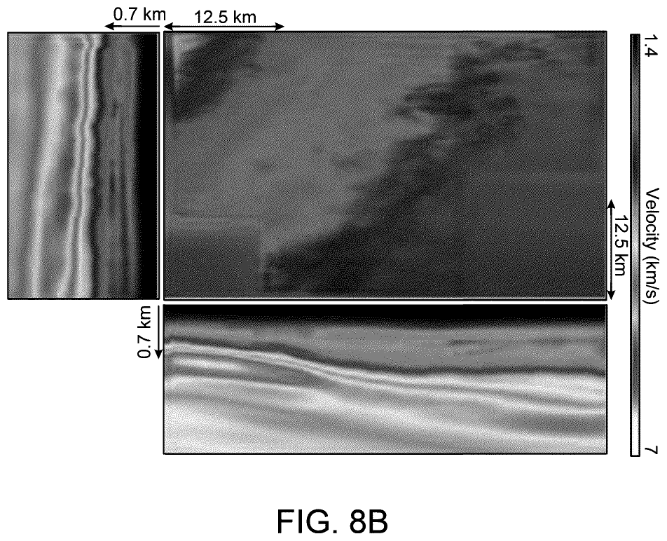

FIG. 8A illustrates an initial model used in an FWI process to develop a final FWI model. FIG. 8B illustrates the final FWI model obtained from the FWI process. The observed shot gathers are from a three-dimensional (3D) land dataset. The observed shot gathers are filtered using a band-pass filter with frequencies of 0.25, 0.5, 7, and 14 Hz. A Ricker wavelet with a peak frequency of 7 Hz is used as the source wavelet for synthetic data generation in the FWI process. The minimum and maximum offsets for the observed shot gathers are set from 500 m and 3600 m, respectively. Window lengths in the time and space directions, i.e., windowₜ and windowₓ in Equation 1, are configured at 150 ms and 400 m, respectively, with weighting factors λₜ and λₓ in Equation 1 set to 0.5 each. When compared to the initial model in FIG. 8A, the final FWI model in FIG. 8B shows, for example, in the depth slice in the upper right rectangle area, more detailed velocity trend corresponding to the true geological trend, and the top and bottom boundaries of the high velocity layer in the upper right rectangle area are well delineated in the final FWI model in FIG. 8B.

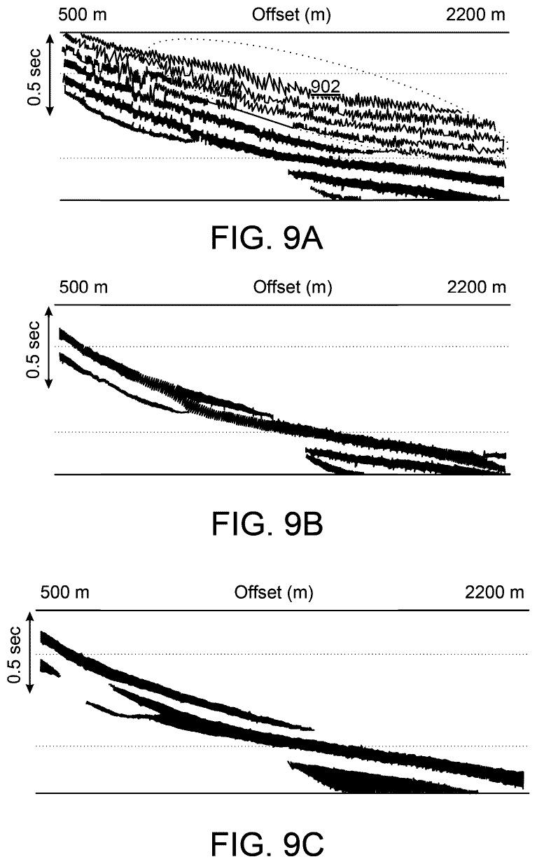

FIG. 9A illustrates an example of observed traces from 500 m to 2200 m offsets, which can represent short to intermediate offsets. The observed traces in FIG. 9A show noticeable contamination by background noises, for example, within area 902 of FIG. 9A.

FIG. 9B illustrates an example of synthetic traces corresponding to the observed traces in FIG. 9A and obtained from the initial model in FIG. 8A.

FIG. 9C illustrates an example of synthetic traces corresponding to the observed traces in FIG. 9A and obtained from the final FWI model in FIG. 8B. The synthetic traces in FIG. 9C show a closer match with the observed traces in FIG. 9A when compared to those in FIG. 9B. FIGS. 9A to 9C show that process 100 is effective in developing the FWI model, even when process 100 is implemented in the presence of noisy observed shot gathers.

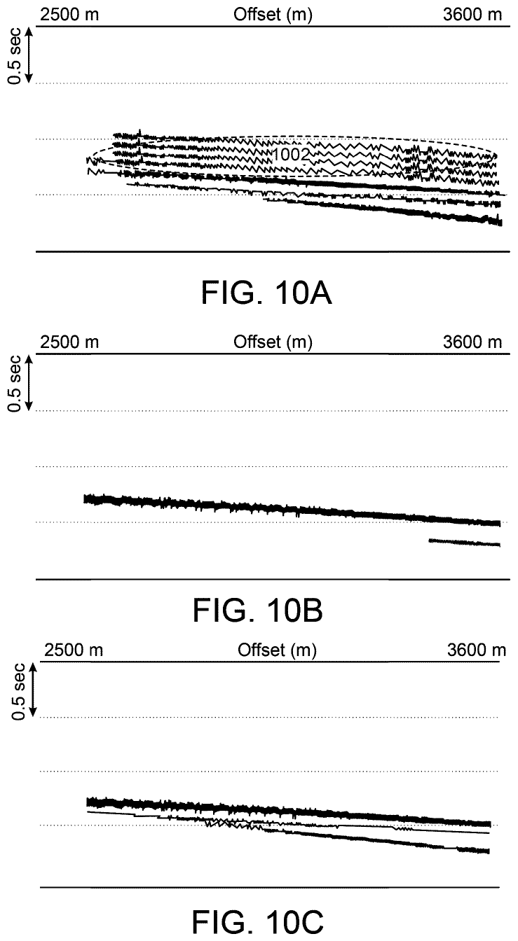

FIG. 10A illustrates an example of observed traces from 2500 m to 3600 m offsets, which can represent intermediate to far offsets. FIG. 10B illustrates an example of synthetic traces corresponding to the observed traces in FIG. 10A and obtained from the initial model in FIG. 8A. FIG. 10C illustrates an example of synthetic traces corresponding to the observed traces in FIG. 10A and obtained from the final FWI model in FIG. 8B. The observed traces at far offsets, for example, the observed traces within area 1002 of FIG. 10A, exhibit less contamination by background noises in comparison to observed traces at short offsets, for example, the observed traces within area 902 of FIG. 9A. As shown in FIGS. 10A and 10C, the synthetic traces derived from the final FWI model closely resemble the observed traces, even at far offsets. In some implementations, the final FWI model used to generate the synthetic traces in FIGS. 9C and 10C can be used for long-wavelength static correction in time processing of seismic migration. The velocity model can also be used for deeper model building for depth seismic processing. The depth and/or time migration results obtained from the final FWI model can provide geological structure under surface and can be used for finding potential reservoir locations. In some cases, the final FWI model can be used in seismic data interpretation to help mitigate risks in seismic structural interpretation and reservoir characterization.

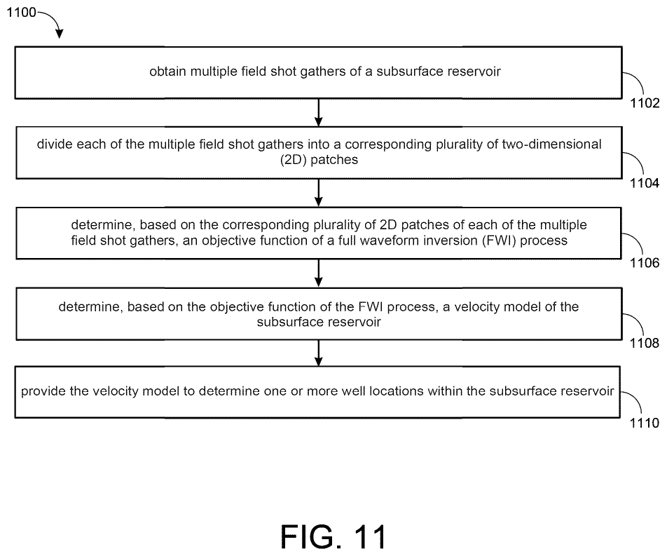

FIG. 11 illustrates an example process 1100 for FWI incorporating the objective function in Equation 1. For convenience, process 1100 will be described as being performed by a computer system having one or more computers located in one or more locations and programmed appropriately in accordance with this specification. An example of the computer system is the computer system 1200 illustrated in FIG. 12.

At 1102, a computer system obtains multiple field shot gathers of a subsurface reservoir.

At 1104, the computer system divides each of the multiple field shot gathers into corresponding multiple two-dimensional (2D) patches.

At 1106, the computer system determines, based on the corresponding plurality of 2D patches of each of the multiple field shot gathers, an objective function of a full waveform inversion (FWI) process.

At 1108, the computer system determines, based on the objective function of the FWI process, a velocity model of the subsurface reservoir.

At 1110, the computer system provides the velocity model to determine one or more well locations within the subsurface reservoir.

FIG. 12 is a block diagram of an example computer system 1200 that can be used to provide computational functionalities associated with described algorithms, methods, functions, processes, flows, and procedures, according to some implementations of the present disclosure. In some implementations, the computer system performing process 100 or 1100 can be the computer system 1200, include the computer system 1200, or the computer system performing process 100 or 1100 can communicate with the computer system 1200.

The illustrated computer 1202 is intended to encompass any computing device such as a server, a desktop computer, an embedded computer, a laptop/notebook computer, a wireless data port, a smart phone, a personal data assistant (PDA), a tablet computing device, or one or more processors within these devices, including physical instances, virtual instances, or both. The computer 1202 can include input devices such as keypads, keyboards, and touch screens that can accept user information. Also, the computer 1202 can include output devices that can convey information associated with the operation of the computer 1202. The information can include digital data, visual data, audio information, or a combination of information. The information can be presented in a graphical user interface (UI) (or GUI). In some implementations, the inputs and outputs include display ports (such as DVI-I+2x display ports), USB 3.0, GbE ports, isolated DI/O, SATA-III (6.0 Gb/s) ports, mPCIe slots, a combination of these, or other ports. In instances of an edge gateway, the computer 1202 can include a Smart Embedded Management Agent (SEMA), such as a built-in ADLINK SEMA 2.2, and a video sync technology, such as Quick Sync Video technology supported by ADLINK MSDK+. In some examples, the computer 1202 can include the MXE-5400 Series processor-based fanless embedded computer by ADLINK, though the computer 1202 can take other forms or include other components.

The computer 1202 can serve in a role as a client, a network component, a server, a database, a persistency, or components of a computer system for performing the subject matter described in the present disclosure. The illustrated computer 1202 is communicably coupled with a network 1230. In some implementations, one or more components of the computer 1202 can be configured to operate within different environments, including cloud-computing-based environments, local environments, global environments, and combinations of environments.

At a high level, the computer 1202 is an electronic computing device operable to receive, transmit, process, store, and manage data and information associated with the described subject matter. According to some implementations, the computer 1202 can also include, or be communicably coupled with, an application server, an email server, a web server, a caching server, a streaming data server, or a combination of servers.

The computer 1202 can receive requests over network 1230 from a client application (for example, executing on another computer 1202). The computer 1202 can respond to the received requests by processing the received requests using software applications. Requests can also be sent to the computer 1202 from internal users (for example, from a command console), external (or third) parties, automated applications, entities, individuals, systems, and computers.

Each of the components of the computer 1202 can communicate using a system bus 1203. In some implementations, any or all of the components of the computer 1202, including hardware or software components, can interface with each other or the interface 1204 (or a combination of both), over the system bus. Interfaces can use an application programming interface (API) 1212, a service layer 1213, or a combination of the API 1212 and service layer 1213. The API 1212 can include specifications for routines, data structures, and object classes. The API 1212 can be either computer-language independent or dependent. The API 1212 can refer to a complete interface, a single function, or a set of APIs 1212.

The service layer 1213 can provide software services to the computer 1202 and other components (whether illustrated or not) that are communicably coupled to the computer 1202. The functionality of the computer 1202 can be accessible for all service consumers using this service layer 1213. Software services, such as those provided by the service layer 1213, can provide reusable, defined functionalities through a defined interface. For example, the interface can be software written in JAVA, C++, or a language providing data in extensible markup language (XML) format. While illustrated as an integrated component of the computer 1202, in alternative implementations, the API 1212 or the service layer 1213 can be stand-alone components in relation to other components of the computer 1202 and other components communicably coupled to the computer 1202. Moreover, any or all parts of the API 1212 or the service layer 1213 can be implemented as child or sub-modules of another software module, enterprise application, or hardware module without departing from the scope of the present disclosure.

The computer 1202 can include an interface 1204. Although illustrated as a single interface 1204 in FIG. 12, two or more interfaces 1204 can be used according to particular needs, desires, or particular implementations of the computer 1202 and the described functionality. The interface 1204 can be used by the computer 1202 for communicating with other systems that are connected to the network 1230 (whether illustrated or not) in a distributed environment. Generally, the interface 1204 can include, or be implemented using, logic encoded in software or hardware (or a combination of software and hardware) operable to communicate with the network 1230. More specifically, the interface 1204 can include software supporting one or more communication protocols associated with communications. As such, the network 1230 or the interface's hardware can be operable to communicate physical signals within and outside of the illustrated computer 1202.

The computer 1202 includes a processor 1205. Although illustrated as a single processor 1205 in FIG. 12, two or more processors 1205 can be used according to particular needs, desires, or particular implementations of the computer 1202 and the described functionality. Generally, the processor 1205 can execute instructions and manipulate data to perform the operations of the computer 1202, including operations using algorithms, methods, functions, processes, flows, and procedures as described in the present disclosure.

The computer 1202 can also include a database 1206 that can hold data for the computer 1202 and other components connected to the network 1230 (whether illustrated or not). For example, database 1206 can be an in-memory, conventional, or a database storing data consistent with the present disclosure. In some implementations, the database 1206 can be a combination of two or more different database types (for example, hybrid in-memory and conventional databases) according to particular needs, desires, or particular implementations of the computer 1202 and the described functionality. Although illustrated as a single database 1206 in FIG. 12, two or more databases (of the same, different, or combination of types) can be used according to particular needs, desires, or particular implementations of the computer 1202 and the described functionality. While database 1206 is illustrated as an internal component of the computer 1202, in alternative implementations, database 1206 can be external to the computer 1202.

The computer 1202 also includes a memory 1207 that can hold data for the computer 1202 or a combination of components connected to the network 1230 (whether illustrated or not). Memory 1207 can store any data consistent with the present disclosure. In some implementations, memory 1207 can be a combination of two or more different types of memory (for example, a combination of semiconductor and magnetic storage) according to particular needs, desires, or particular implementations of the computer 1202 and the described functionality. Although illustrated as a single memory 1207 in FIG. 12, two or more memories 1207 (of the same, different, or combination of types) can be used according to particular needs, desires, or particular implementations of the computer 1202 and the described functionality. While memory 1207 is illustrated as an internal component of the computer 1202, in alternative implementations, memory 1207 can be external to the computer 1202.

An application 1208 can be an algorithmic software engine providing functionality according to particular needs, desires, or particular implementations of the computer 1202 and the described functionality. For example, an application 1208 can serve as one or more components, modules, or applications 1208. Multiple applications 1208 can be implemented on the computer 1202. Each application 1208 can be internal or external to the computer 1202.

The computer 1202 can also include a power supply 1214. The power supply 1214 can include a rechargeable or non-rechargeable battery that can be configured to be either user- or non-user-replaceable. In some implementations, the power supply 1214 can include power-conversion and management circuits, including recharging, standby, and power management functionalities. In some implementations, the power-supply 1214 can include a power plug to allow the computer 1202 to be plugged into a wall socket or a power source to, for example, power the computer 1202 or recharge a rechargeable battery.

There can be any number of computers 1202 associated with, or external to, a computer system including computer 1202, with each computer 1202 communicating over network 1230. Further, the terms “client”, “user”, and other appropriate terminology can be used interchangeably without departing from the scope of the present disclosure. Moreover, the present disclosure contemplates that many users can use one computer 1202 and one user can use multiple computers 1202.

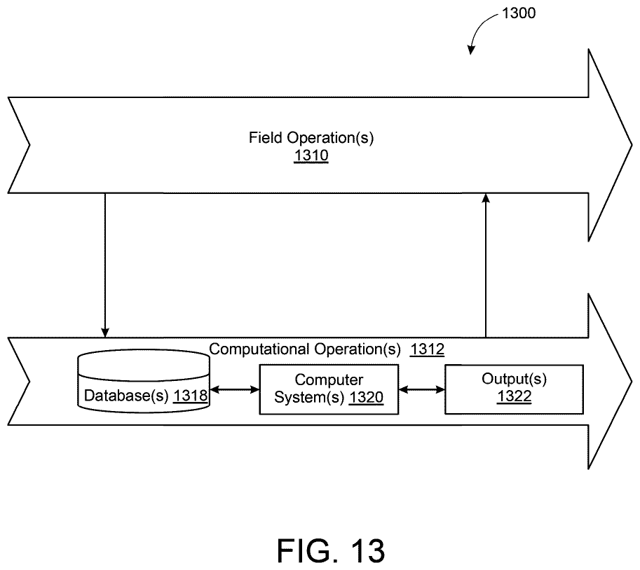

FIG. 13 illustrates hydrocarbon production operations 1300 that include both one or more field operations 1310 and one or more computational operations 1312, which exchange information and control exploration for the production of hydrocarbons. In some implementations, outputs of techniques of the present disclosure can be performed before, during, or in combination with the hydrocarbon production operations 1300, specifically, for example, either as field operations 1310 or computational operations 1312, or both.

Examples of field operations 1310 include forming/drilling a wellbore, hydraulic fracturing, producing through the wellbore, injecting fluids (such as water) through the wellbore, to name a few. In some implementations, methods of the present disclosure can trigger or control the field operations 1310. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 1310 and responsively triggering the field operations 1310 including, for example, generating plans and signals that provide feedback to and control physical components of the field operations 1310. Alternatively or in addition, the field operations 1310 can trigger the methods of the present disclosure. For example, implementing physical components (including, for example, hardware, such as sensors) deployed in the field operations 1310 can generate plans and signals that can be provided as input or feedback (or both) to the methods of the present disclosure.

Examples of computational operations 1312 include one or more computer systems 1320 that include one or more processors and computer-readable media (e.g., non-transitory computer-readable media) operatively coupled to the one or more processors to execute computer operations to perform the methods of the present disclosure. The computational operations 1312 can be implemented using one or more databases 1318, which store data received from the field operations 1310 and/or generated internally within the computational operations 1312 (e.g., by implementing the methods of the present disclosure) or both. For example, the one or more computer systems 1320 process inputs from the field operations 1310 to assess conditions in the physical world, the outputs of which are stored in the databases 1318. For example, seismic sensors of the field operations 1310 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 1312 where they are stored in the databases 1318 and analyzed by the one or more computer systems 1320.

In some implementations, one or more outputs 1322 generated by the one or more computer systems 1320 can be provided as feedback/input to the field operations 1310 (either as direct input or stored in the databases 1318). The field operations 1310 can use the feedback/input to control physical components used to perform the field operations 1310 in the real world.

For example, the computational operations 1312 can process the seismic data to generate three-dimensional (3D) maps of the subsurface formation. The computational operations 1312 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 1312 to process new information about the formation and control the drilling to adjust to the observed conditions in real-time.

The one or more computer systems 1320 can update the 3D maps of the subsurface formation as information from one exploration well is received and the computational operations 1312 can adjust the location of the next exploration well based on the updated 3D maps. Similarly, the data received from production operations can be used by the computational operations 1312 to control components of the production operations. For example, production well and pipeline data can be analyzed to predict slugging in pipelines leading to a refinery and the computational operations 1312 can control machine operated valves upstream of the refinery to reduce the likelihood of plant disruptions that run the risk of taking the plant offline.

In some implementations of the computational operations 1312, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

Implementations of the subject matter and the functional operations described in this specification can be implemented in digital electronic circuitry, in tangibly embodied computer software or firmware; in computer hardware, including the structures disclosed in this specification and their structural equivalents; or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus”, “computer”, and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus and special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, Linux, Unix, Windows, Mac OS, Android, or iOS.

A computer program, which can also be referred to or described as a program, software, a software application, a module, a software module, a script, or code can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document; in a single file dedicated to the program in question; or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes; the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks, optical memory devices, and technologies including, for example, digital video disc (DVD), CD ROM, DVD+/−R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), or a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The term “graphical user interface,” or “GUI,” can be used in the singular or the plural to describe one or more graphical user interfaces and each of the displays of a particular graphical user interface. Therefore, a GUI can represent any graphical user interface, including, but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser. Implementations of the subject matter described in this specification can be implemented in a computing system that includes a back end component, for example, as a data server, or that includes a middleware component, for example, an application server. Moreover, the computing system can include a front-end component, for example, a client computer having one or both of a graphical user interface or a Web browser through which a user can interact with the computer. The components of the system can be interconnected by any form or medium of wireline or wireless digital data communication (or a combination of data communication) in a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, or in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations; and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

### EMBODIMENTS

Embodiment 1: A computer-implemented method, comprising: obtaining a plurality of field shot gathers of a subsurface reservoir; dividing each of the plurality of field shot gathers into a corresponding plurality of two-dimensional (2D) patches; determining, based on the corresponding plurality of 2D patches of each of the plurality of field shot gathers, an objective function of a full waveform inversion (FWI) process; determining, based on the objective function of the FWI process, a velocity model of the subsurface reservoir; and providing the velocity model to determine one or more well locations within the subsurface reservoir.
Embodiment 2: The computer-implemented method of embodiment 1, comprising: before dividing each of the plurality of field shot gathers into the corresponding plurality of 2D patches, filtering the plurality of field shot gathers to generate a plurality of shape-filtered field shot gathers, wherein filtering the plurality of field shot gathers comprises convolving the plurality of field shot gathers with a shaping filter, and wherein dividing each of the plurality of field shot gathers into the corresponding plurality of 2D patches comprises dividing each of the plurality of shape-filtered field shot gathers into the corresponding plurality of 2D patches.
Embodiment 3: The computer-implemented method of embodiment 1 or 2, wherein determining the objective function of the FWI process comprises: determining, for each of the corresponding plurality of 2D patches, a respective soft-dynamic time warping (DTW) objective function in a time direction and a respective soft-DTW objective function in a space direction; and determining, based on the respective soft-DTW objective function in the time direction and the respective soft-DTW objective function in the space direction, the objective function of the FWI process.
Embodiment 4: The computer-implemented method of embodiment 3, wherein determining the respective soft-DTW objective function in the time direction comprises determining, based on a weighting function, the respective soft-DTW objective function in the time direction.
Embodiment 5: The computer-implemented method of any one of embodiments 1 to 4, wherein determining the objective function of the FWI process comprises determining, based on a respective synthetic shot gather within each of the corresponding plurality of 2D patches, the objective function of the FWI process.
Embodiment 6: The computer-implemented method of embodiment 5, wherein the respective synthetic shot gather within each of the corresponding plurality of 2D patches is generated using a Ricker wavelet.
Embodiment 7: The computer-implemented method of any one of embodiments 1 to 6, wherein determining the velocity model of the subsurface reservoir comprises determining, based on the objective function of the FWI process and an adjoint source vector of the objective function of the FWI process, the velocity model of the subsurface reservoir.
Embodiment 8: A non-transitory computer-readable medium storing one or more instructions executable by a computer system to perform operations comprising: obtaining a plurality of field shot gathers of a subsurface reservoir; dividing each of the plurality of field shot gathers into a corresponding plurality of two-dimensional (2D) patches; determining, based on the corresponding plurality of 2D patches of each of the plurality of field shot gathers, an objective function of a full waveform inversion (FWI) process; determining, based on the objective function of the FWI process, a velocity model of the subsurface reservoir; and providing the velocity model to determine one or more well locations within the subsurface reservoir.
Embodiment 9: The non-transitory computer-readable medium of embodiment 8, wherein the operations further comprise: before dividing each of the plurality of field shot gathers into the corresponding plurality of 2D patches, filtering the plurality of field shot gathers to generate a plurality of shape-filtered field shot gathers, wherein filtering the plurality of field shot gathers comprises convolving the plurality of field shot gathers with a shaping filter, and wherein dividing each of the plurality of field shot gathers into the corresponding plurality of 2D patches comprises dividing each of the plurality of shape-filtered field shot gathers into the corresponding plurality of 2D patches.
Embodiment 10: The non-transitory computer-readable medium of embodiment 8 or 9, wherein determining the objective function of the FWI process comprises: determining, for each of the corresponding plurality of 2D patches, a respective soft-dynamic time warping (DTW) objective function in a time direction and a respective soft-DTW objective function in a space direction; and determining, based on the respective soft-DTW objective function in the time direction and the respective soft-DTW objective function in the space direction, the objective function of the FWI process.
Embodiment 11: The non-transitory computer-readable medium of embodiment 10, wherein determining the respective soft-DTW objective function in the time direction comprises determining, based on a weighting function, the respective soft-DTW objective function in the time direction.
Embodiment 12: The non-transitory computer-readable medium of any one of embodiments 8 to 11, wherein determining the objective function of the FWI process comprises determining, based on a respective synthetic shot gather within each of the corresponding plurality of 2D patches, the objective function of the FWI process.
Embodiment 13: The non-transitory computer-readable medium of embodiment 12, wherein the respective synthetic shot gather within each of the corresponding plurality of 2D patches is generated using a Ricker wavelet.
Embodiment 14: The non-transitory computer-readable medium of any one of embodiments 8 to 13, wherein determining the velocity model of the subsurface reservoir comprises determining, based on the objective function of the FWI process and an adjoint source vector of the objective function of the FWI process, the velocity model of the subsurface reservoir.
Embodiment 15: A computer-implemented system comprising: one or more computers; and one or more computer memory devices interoperably coupled with the one or more computers and having tangible, non-transitory, machine-readable media storing one or more instructions that, when executed by the one or more computers, cause the computer-implemented system to perform one or more operations comprising: obtaining a plurality of field shot gathers of a subsurface reservoir; dividing each of the plurality of field shot gathers into a corresponding plurality of two-dimensional (2D) patches; determining, based on the corresponding plurality of 2D patches of each of the plurality of field shot gathers, an objective function of a full waveform inversion (FWI) process; determining, based on the objective function of the FWI process, a velocity model of the subsurface reservoir; and providing the velocity model to determine one or more well locations within the subsurface reservoir.
Embodiment 16: The computer-implemented system of embodiment 15, wherein the one or more operations further comprise: before dividing each of the plurality of field shot gathers into the corresponding plurality of 2D patches, filtering the plurality of field shot gathers to generate a plurality of shape-filtered field shot gathers, wherein filtering the plurality of field shot gathers comprises convolving the plurality of field shot gathers with a shaping filter, and wherein dividing each of the plurality of field shot gathers into the corresponding plurality of 2D patches comprises dividing each of the plurality of shape-filtered field shot gathers into the corresponding plurality of 2D patches
Embodiment 17: The computer-implemented system of embodiment 15 or 16, wherein determining the objective function of the FWI process comprises: determining, for each of the corresponding plurality of 2D patches, a respective soft-dynamic time warping (DTW) objective function in a time direction and a respective soft-DTW objective function in a space direction; and determining, based on the respective soft-DTW objective function in the time direction and the respective soft-DTW objective function in the space direction, the objective function of the FWI process.
Embodiment 18: The computer-implemented system of embodiment 17, wherein determining the respective soft-DTW objective function in the time direction comprises determining, based on a weighting function, the respective soft-DTW objective function in the time direction.
Embodiment 19: The computer-implemented system of any one of embodiments 15 to 18, wherein determining the objective function of the FWI process comprises determining, based on a respective synthetic shot gather within each of the corresponding plurality of 2D patches, the objective function of the FWI process.
Embodiment 20: The computer-implemented system of embodiment 19, wherein the respective synthetic shot gather within each of the corresponding plurality of 2D patches is generated using a Ricker wavelet.

What is claimed is:

1. A computer-implemented method, comprising:
obtaining a plurality of field shot gathers of a subsurface reservoir;
dividing each of the plurality of field shot gathers into a corresponding plurality of two-dimensional (2D) patches;
determining, based on the corresponding plurality of 2D patches of each of the plurality of field shot gathers, an objective function of a full waveform inversion (FWI) process;
determining, based on the objective function of the FWI process, a velocity model of the subsurface reservoir; and
providing the velocity model to determine one or more well locations within the subsurface reservoir.

2. The computer-implemented method of claim 1, comprising:
before dividing each of the plurality of field shot gathers into the corresponding plurality of 2D patches, filtering the plurality of field shot gathers to generate a plurality of shape-filtered field shot gathers, wherein filtering the plurality of field shot gathers comprises convolving the plurality of field shot gathers with a shaping filter, and wherein dividing each of the plurality of field shot gathers into the corresponding plurality of 2D patches comprises dividing each of the plurality of shape-filtered field shot gathers into the corresponding plurality of 2D patches.

3. The computer-implemented method of claim 1, wherein determining the objective function of the FWI process comprises:
determining, for each of the corresponding plurality of 2D patches, a respective soft-dynamic time warping (DTW) objective function in a time direction and a respective soft-DTW objective function in a space direction; and
determining, based on the respective soft-DTW objective function in the time direction and the respective soft-DTW objective function in the space direction, the objective function of the FWI process.

4. The computer-implemented method of claim 3, wherein determining the respective soft-DTW objective function in the time direction comprises determining, based on a weighting function, the respective soft-DTW objective function in the time direction.

5. The computer-implemented method of claim 1, wherein determining the objective function of the FWI process comprises determining, based on a respective synthetic shot gather within each of the corresponding plurality of 2D patches, the objective function of the FWI process.

6. The computer-implemented method of claim 5, wherein the respective synthetic shot gather within each of the corresponding plurality of 2D patches is generated using a Ricker wavelet.

7. The computer-implemented method of claim 1, wherein determining the velocity model of the subsurface reservoir comprises determining, based on the objective function of the FWI process and an adjoint source vector of the objective function of the FWI process, the velocity model of the subsurface reservoir.

8. A non-transitory computer-readable medium storing one or more instructions executable by a computer system to perform operations comprising:
obtaining a plurality of field shot gathers of a subsurface reservoir;
dividing each of the plurality of field shot gathers into a corresponding plurality of two-dimensional (2D) patches;
determining, based on the corresponding plurality of 2D patches of each of the plurality of field shot gathers, an objective function of a full waveform inversion (FWI) process;
determining, based on the objective function of the FWI process, a velocity model of the subsurface reservoir; and
providing the velocity model to determine one or more well locations within the subsurface reservoir.

9. The non-transitory computer-readable medium of claim 8, wherein the operations further comprise:
before dividing each of the plurality of field shot gathers into the corresponding plurality of 2D patches, filtering the plurality of field shot gathers to generate a plurality of shape-filtered field shot gathers, wherein filtering the plurality of field shot gathers comprises convolving the plurality of field shot gathers with a shaping filter, and wherein dividing each of the plurality of field shot gathers into the corresponding plurality of 2D patches comprises dividing each of the plurality of shape-filtered field shot gathers into the corresponding plurality of 2D patches.

10. The non-transitory computer-readable medium of claim 8, wherein determining the objective function of the FWI process comprises:
determining, for each of the corresponding plurality of 2D patches, a respective soft-dynamic time warping (DTW) objective function in a time direction and a respective soft-DTW objective function in a space direction; and
determining, based on the respective soft-DTW objective function in the time direction and the respective soft-DTW objective function in the space direction, the objective function of the FWI process.

11. The non-transitory computer-readable medium of claim 10, wherein determining the respective soft-DTW objective function in the time direction comprises determining, based on a weighting function, the respective soft-DTW objective function in the time direction.

12. The non-transitory computer-readable medium of claim 8, wherein determining the objective function of the FWI process comprises determining, based on a respective synthetic shot gather within each of the corresponding plurality of 2D patches, the objective function of the FWI process.

13. The non-transitory computer-readable medium of claim 12, wherein the respective synthetic shot gather within each of the corresponding plurality of 2D patches is generated using a Ricker wavelet.

14. The non-transitory computer-readable medium of claim 8, wherein determining the velocity model of the subsurface reservoir comprises determining, based on the objective function of the FWI process and an adjoint source vector of the objective function of the FWI process, the velocity model of the subsurface reservoir.

15. A computer-implemented system comprising:
one or more computers; and
one or more computer memory devices interoperably coupled with the one or more computers and having tangible, non-transitory, machine-readable media storing one or more instructions that, when executed by the one or more computers, cause the computer-implemented system to perform one or more operations comprising:
obtaining a plurality of field shot gathers of a subsurface reservoir;
dividing each of the plurality of field shot gathers into a corresponding plurality of two-dimensional (2D) patches;
determining, based on the corresponding plurality of 2D patches of each of the plurality of field shot gathers, an objective function of a full waveform inversion (FWI) process;
determining, based on the objective function of the FWI process, a velocity model of the subsurface reservoir; and
providing the velocity model to determine one or more well locations within the subsurface reservoir.

16. The computer-implemented system of claim 15, wherein the one or more operations further comprise:
before dividing each of the plurality of field shot gathers into the corresponding plurality of 2D patches, filtering the plurality of field shot gathers to generate a plurality of shape-filtered field shot gathers, wherein filtering the plurality of field shot gathers comprises convolving the plurality of field shot gathers with a shaping filter, and wherein dividing each of the plurality of field shot gathers into the corresponding plurality of 2D patches comprises dividing each of the plurality of shape-filtered field shot gathers into the corresponding plurality of 2D patches.

17. The computer-implemented system of claim 15, wherein determining the objective function of the FWI process comprises:
determining, for each of the corresponding plurality of 2D patches, a respective soft-dynamic time warping (DTW) objective function in a time direction and a respective soft-DTW objective function in a space direction; and
determining, based on the respective soft-DTW objective function in the time direction and the respective soft-DTW objective function in the space direction, the objective function of the FWI process.

18. The computer-implemented system of claim 17, wherein determining the respective soft-DTW objective function in the time direction comprises determining, based on a weighting function, the respective soft-DTW objective function in the time direction.

19. The computer-implemented system of claim 15, wherein determining the objective function of the FWI process comprises determining, based on a respective synthetic shot gather within each of the corresponding plurality of 2D patches, the objective function of the FWI process.

20. The computer-implemented system of claim 19, wherein the respective synthetic shot gather within each of the corresponding plurality of 2D patches is generated using a Ricker wavelet.
